(19) United States
(12) Patent Application Publication
(10) Pub. No.: US 2010/0227201 A1
(43) Pub. Date: Sep. 9, 2010

(54) MAGNETIC RECORDING MEDIUM

(75) Inventors: Yuji SASAKI, Ibaraki-shi (JP); Toshiyuki Watanabe, Ibaraki-shi (JP); Takayuki Owaki, Ibaraki-shi (JP); Tetsutaro Inoue, Ibaraki-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 12/715,990

(22) Filed: Mar. 2, 2010

(30) Foreign Application Priority Data
Mar. 3, 2009 (JP) 2009-048852
Jan. 13, 2010 (JP) 2010-004606

(51) Int. Cl. G11B 5/716

(52) U.S. Cl. 428/839

(57) ABSTRACT

A magnetic recording medium having a nonmagnetic substrate, and a soft magnetic layer and a ferromagnetic layer having a thickness of 5 to 150 nm formed in this order on the nonmagnetic substrate, in which, the ferromagnetic layer contains a spherical, ellipsoidal or plate-form ferromagnetic powder and a binder, and has an axis of easy magnetization substantially in a perpendicular direction, and the soft magnetic layer contains a spherical or ellipsoidal magnetite soft magnetic powder having a particle size of 30 nm or less, a rate of variation in particle size of 20% or less and a saturation magnetization of 10 to 60 Am²/kg, and a binder.

### FIELD OF THE INVENTION

The present invention relates to a coating type magnetic recording medium. In particular, the present invention relates to a coating type magnetic recording medium comprising a soft magnetic layer and a ferromagnetic layer having an axis of easy magnetization in a vertical direction formed on the soft magnetic layer.

Coating type magnetic recording media which comprise a magnetic layer containing a magnetic powder dispersed in a binder are required to be further improved in recording density characteristics, since recording-reproducing systems progress from analog systems to digital systems. This requirement has been growing year after year, especially in the field of magnetic recording media for use in high density digital video tapes, computer backup tapes, etc.

To improve the recording density characteristics of such recording media, the particle size of magnetic powder is made smaller and smaller in these years so as to correspond to the trend of recording with shorter wavelengths. Presently, magnetic powders comprising acicular iron-based metal magnetic particles with a longer axis of about 0.1 μm are practically used. In addition, to prevent output decrease due to demagnetization during recording with short wavelengths, magnetic powders having a larger coercive force have been developed in these years. For example, a magnetic powder which comprises iron-based metal magnetic particles and has a coercive force of about 199.0 kA/m has been realized by iron-cobalt alloying (JP-A-03-49026). However, in the case of a magnetic recording medium comprising these acicular magnetic particles, the coercive force thereof depends on the shape of the magnetic particles. Therefore, in the state of art, the development of very fine particles having a largely decreased major axis is difficult.

When the wavelengths of signals to be recorded are decreased for the purpose of high density recording, there arise not only a problem that an output from a recording medium becomes several times lower relative to such signals within the short wavelength range, because of the levels of the saturation magnetization and coercive force of the conventional magnetic powder, but also a problem that the influences of a self-demagnetization loss during the recording/reproducing of signals and a thickness loss attributed to the thickness of a magnetic layer become more serious, which leads to insufficient resolution. For these reasons, a magnetic recording medium with a multi-layer structure comprising a nonmagnetic layer as a lower layer and a magnetic layer with a thickness of about 0.2 μm as an upper layer are practically used for a computer backup tape such as LTO (Linear Tape Open) and DLT (Digital Linear Tape), in order to reduce the thickness of the magnetic layer.

In the above-described magnetic recording media, the magnetic particles are oriented in the lengthwise direction of the media. On the other hand, there are proposed some magnetic recording media comprising a magnetic layer containing magnetic particles oriented in a vertical direction to have an axis of easy magnetization in the vertical direction so that the vertical component of the residual magnetization of the magnetic layer becomes larger than the in-plane component, in order to improve the reproduction output (JP-A-57-183626, JP-A-59-167854 and JP-A-2-254621). The magnetic recording medium of this type in which the magnetic particles are oriented in the vertical direction has an advantage, i.e., a higher output, because of a small demagnetizing field around a magnetization transition region which is a boundary for a recording bit, and because of a lower self-demagnetization. However, the conventional acicular magnetic particles are easily oriented in the lengthwise direction by the mechanical orientation during coating, and thus, it is difficult to orient such magnetic particles in the vertical direction, and the surface smoothness of the resultant magnetic layer tends to degrade since the magnetic particles project from the surface of the magnetic layer due to the vertical orientation thereof. Therefore, it is essentially unsuitable to orient acicular magnetic particles in the vertical direction in a thickness range of the magnetic layer in which the major axial length of the acicular magnetic particles is of the same level as the thickness of the magnetic layer. Therefore, no coating type magnetic recording medium that comprises a magnetic layer containing magnetic particles oriented in the vertical direction has been commercialized so far.

Under such a situation, a magnetic recording medium was proposed, which comprises a low coercive force layer containing magnetic particles with a low coercive force, and a thin upper magnetic layer having a thickness of, for example, 150 nm or less and containing fine particulate iron nitride-based magnetic particles having a particle size of 5 to 50 nm oriented in a vertical direction, formed on the low coercive force layer (JP-A-2004-335019). According to this magnetic recording medium, the upper magnetic layer has a superior surface smoothness, even if the thickness thereof is thin, since the upper magnetic layer contains the particulate iron nitride-based magnetic particles having a high coercive force and a high saturation magnetization. Therefore, this magnetic recording medium can show a high reproduction output.

It has been studied to apply, as a magnetic head used for reproducing recorded information, a high-sensitivity magnetic head such as a magnetoresistance effect magnetic head (MR head), an anisotropic magnetoresistance effect magnetic head (AMR head), a giant magnetoresistance effect magnetic head (GMR head) and a tunnel magnetoresistance effect magnetic head (TMR head), which are hereinafter collectively referred to as “MR head”, in place of a conventional inductive head for a data recording system for computers. In a system using the MR head, noise caused by the system can be remarkably reduced, and thus a medium noise originating from a magnetic recording medium has a dominant influence on a signal-noise ratio (SNR) of the system. Therefore, it is necessary to increase an output and also reduce noise in a magnetic recording medium using a magnetic powder suitable for vertical recording.

The medium noise originating from a magnetic recording medium is roughly classified into particle noise and modulation noise. According to the technique described in JP-A-2004-335019, since a particulate iron nitride-based magnetic powder is vertically oriented as described above, modulation noise caused by surface roughness can be reduced. However, as the result of researches by the present inventors, it was revealed that the particle noise cannot be sufficiently reduced even if such a particulate ferromagnetic powder is used. It is required to reduce particle noise since the particle noise has an adverse influence in a wide frequency range and serves as a principal cause for the medium noise.

### SUMMARY OF THE INVENTION

An object of the present invention is to provide a coating type magnetic recording medium having an excellent reproduction output and exhibiting reduced particle noise, which is provided with a thin ferromagnetic layer having an axis of easy magnetization in a vertical direction using a spherical, ellipsoidal or plate-form ferromagnetic powder.

Accordingly, the present invention provides a magnetic recording medium comprising a nonmagnetic substrate, and a soft magnetic layer and a ferromagnetic layer having a thickness of 5 to 150 nm formed in this order on the nonmagnetic substrate, wherein the ferromagnetic layer contains a spherical, ellipsoidal or plate-form ferromagnetic powder and a binder, and has an axis of easy magnetization substantially in a perpendicular direction, and the soft magnetic layer contains a spherical or ellipsoidal magnetite soft magnetic powder having a particle size of 30 nm or less, a rate of variation in particle size of 20% or less and a saturation magnetization of 10 to 60 Am²/kg, and a binder.

The magnetite soft magnetic powder preferably has a coercive force of 2 to 12 kA/m.

The ferromagnetic powder is preferably a magnetic powder selected from the group consisting of an iron nitride-based magnetic powder and a Co-based ferromagnetic powder.

The magnetic recording medium of the present invention has an excellent reproduction output and a reduced particle noise.

### DETAILED DESCRIPTION OF THE INVENTION

The magnetic recording medium of the present invention comprises a thin ferromagnetic layer which contains a spherical, ellipsoidal or plate-form ferromagnetic powder and has an axis of easy magnetization in a vertical direction, and a soft magnetic layer which contains a spherical or ellipsoidal magnetite soft magnetic powder having a particle size of 30 nm or less, a rate of variation in particle size of 20% or less and also a saturation magnetization of 10 to 60 Am²/kg, and which is formed under the ferromagnetic layer.

In a coating type magnetic recording medium, when particle noise is evaluated based on the filling amount of a magnetic powder, the particle noise decreases as the number of magnetic powder particles present in each recording bit increases. Therefore, for the reduction of the particle noise, it is effective to improve the filling properties of the magnetic powder in a magnetic layer using a fine particulate magnetic powder. The iron nitride-based magnetic powder described in JP-A-2004-335019 is preferable since it is a fine particulate magnetic powder having a particle size of 5 to 50 nm.

However, the particle noise is not only caused by the physical size of the magnetic powder in the magnetic layer, but also it is influenced by the size of a magnetic cluster formed in the magnetic layer when a signal is recorded. That is, a magnetic field from a magnetic head is applied to the magnetic layer upon recording of a signal, which results in a state where adjacent magnetic powders are magnetically bonded, and an aggregate composed of plural magnetic powders behaves as one magnetic domain, in other words, one minimum unit (a magnetic cluster) which is magnetization-reversed. Accordingly, when the size of the magnetic cluster formed by the application of the magnetic field exceeds the size of a magnetic domain which should be intrinsically formed, a region in which the magnetic particles behave as aggregates enlarges, thus resulting in the increase of the particle noise. While the spherical, ellipsoidal or plate-form ferromagnetic powder is suitable for a vertically oriented medium for the purpose of increasing an output because of its particle shape, the spherical, ellipsoidal or plate-form ferromagnetic powder is likely to be densely filled in the magnetic layer in comparison with a conventional acicular-form ferromagnetic powder, and thus it is supposed that the magnetic interaction generated among magnetic particles increases.

From the above point of view, the present inventors have made investigations for the purpose of decreasing the size of a magnetic cluster formed upon recording of a ferromagnetic layer in which the particles of the spherical, ellipsoidal or plate-form ferromagnetic powder are vertically oriented, and they have found that the particle noise is remarkable reduced by forming a soft magnetic layer which contains a spherical or ellipsoidal magnetite soft magnetic powder having a specific particle size, a rate of variation in particle size and a saturation magnetization adjacent to and under the ferromagnetic layer.

In the present invention, the particle size of the magnetite soft magnetic powder contained in the soft magnetic layer is 30 nm or less. The use of the spherical or ellipsoidal magnetite soft magnetic powder having a small particle size makes it possible to form a soft magnetic layer densely filled with the magnetite soft magnetic powder and to retain the magnetic action of the soft magnetic layer, which weakens the magnetic bond of ferromagnetic particles when the magnetic field is applied during recording. When the particle size is 30 nm or less, the fluctuation of an interface between the soft magnetic layer and the ferromagnetic layer can be suppressed and a high reproduction output can be attained. Thus, the smaller the particle size, the better. However, when the particle size is too small, another problem arises, that is, it becomes difficult to produce a magnetite soft magnetic powder having a predetermined saturation magnetization and a required rate of variation in particle size. Therefore, the particle size is preferably 2 nm or more, more preferably 8 nm or more. The magnetite soft magnetic powder has a spherical or ellipsoidal shape, which has an axial ratio (a ratio of a major axis length to a minor axis length) of 1.0 to 2.5.

The rate of variation in particle size of the magnetite soft magnetic powder is 20% or less, preferably 19% or less. When the rate of variation in particle size exceeds 20%, an effect to decrease the magnetic cluster size cannot be sufficiently obtained since the magnetic action from the soft magnetic layer may become less uniform. When the rate of variation in particle size exceeds 20%, the fluctuation of an interface between the soft magnetic layer and the ferromagnetic layer increases, thus resulting in the decrease of a reproduction output. Therefore, the smaller the rate of variation in particle size, the better. However, the rate of variation in particle size is generally 11% or more when the easiness of the production of the magnetite soft magnetic powder is taken into consideration as with the particle size.

The saturation magnetization of the magnetite soft magnetic powder is from 10 to 60 μm²/kg, preferably from 15 to 55 μm²/kg. When the saturation magnetization is less than 10 μm²/kg, the magnetic action from the soft magnetic layer decreases and thus the effect to decrease the magnetic cluster size cannot be sufficiently obtained. Also, the induction effect of the applied magnetic field upon recording due to the soft magnetic layer decreases, thus resulting in the decrease of writing capability and reproduction output. When the saturation magnetization exceeds 60 Am²/kg, the magnetic action from the soft magnetic layer excessively increases and thus the magnetic cluster size increases.

It is possible to produce a particulate (spherical or ellipsoidal) soft magnetic ferrite powder such as a soft magnetic Mn—Zn ferrite powder, which has the particle size and saturation magnetization similar to those described above. However, in the case of such a soft magnetic powder, when the particle size decreases, the rate of variation in particle size increases and the effect to decrease the size of a magnetic cluster formed in the ferromagnetic layer upon recording cannot be sufficiently obtained.

Herein, the particle size of the magnetic powder is the average value of particle sizes of one hundred magnetic particles selected from the magnetic particles on a photograph taken with a transmission electron microscope (TEM) at a magnification of 200,000. The rate of variation in particle size is defined by a ratio of a standard deviation to an average value (standard deviation/average value) of particle sizes of 100 particles. Furthermore, the saturation magnetization and coercive force of the magnetic powder are values corrected with a reference sample after the measurement with a sample vibration magnetometer at 25° C. under the application of a magnetic field of 1,273.3 kA/m. When the particle size and rate of variation in particle size are determined from a magnetic recording medium, it is possible to determine them by applying the same method as the method of evaluating the particle size of the magnetic powder to particles which are captured from an image obtained by observing a cross section of a sample with a scanning electron microscope (SEM) at a magnification of 100,000.

As a method for measuring magnetic characteristics of the magnetite soft magnetic powder in the soft magnetic layer from a magnetic recording medium, it is possible to calculate the magnetic characteristics by fitting using a hysteresis loop of the magnetic recording medium. Specifically, firstly, the hysteresis loop of the magnetic recording medium is broken down to components of the soft magnetic layer and the ferromagnetic layer. When the value of magnetization measurement of hysteresis is differentiated by the magnetic field, a curve with two peaks is obtained. Since the peaks correspond to the soft magnetic layer and the ferromagnetic layer, respectively, both peaks can be fitted by a Lorenz curve. The sum of two Lorenz curves determined by calculation and a root-mean-square error at each point of the measured value are determined and a parameter is calculated by fitting so as to adjust the mean value within 10%. It is possible to create a hysteresis loop for the soft magnetic layer or the ferromagnetic layer by integrating the respective fitting curve. The saturation magnetization and coercive force can be calculated from the thus obtained hysteresis loop of the soft magnetic layer. This coercive force corresponds to the coercive force of the soft magnetic powder. The number of the magnetic particles per unit volume can be calculated by counting the number of magnetic particles in a cross-sectional micrograph. The saturation magnetization of the soft magnetic powder can be calculated from the number of magnetic particles per unit volume and the saturation magnetization.

The coercive force of the magnetite soft magnetic powder is preferably from 2 to 12 kA/m, more preferably from 7 to 12 kA/m. When the coercive force is too large, the resolution tends to be decreased by a magnetic flux generated from the soft magnetic layer and, in turn, the reproduction output tends to decrease. When the coercive force is too small, the magnetite soft magnetic powder tends to have paramagnetism and thus, the action of the soft magnetic layer tends to decrease.

A method for producing the magnetite soft magnetic powder may be any of a firing and milling method in which raw material powders are blended, fired and milled to obtain fine particles, and a wet method in which particles are formed in an aqueous solution. Among them, the wet method is preferable, since this method can produce the magnetite soft magnetic powder having a smaller rate of variation in particle size, even when the resultant particles have a small particle size. When the magnetite soft magnetic powder is produced by the wet method, preferably, a mixed liquid containing an aqueous solution containing iron ions, a base and a water-soluble reducing organic liquid is prepared and the mixed liquid is heated under pressure. The iron ions may be divalent iron ions or trivalent iron ions, preferably, trivalent iron ions. When divalent iron ions are used, should be subjected to a deoxidation treatment or a treatment under low oxygen conditions, since they are easily oxidized by an air to form trivalent iron ions. If trivalent iron ions are used, they can be stably present in an aqueous solution or a mixed liquid. The aqueous solution containing the trivalent iron ions can be prepared by dissolving a trivalent iron salt in water. Such a trivalent iron salt is not particularly limited, but is preferably at least one salt selected from the group consisting of iron chloride, iron sulfate, iron nitrate, iron acetate and an acetylacetonatoiron complex. Of these trivalent iron salts, iron chloride is more preferable. The concentration of the trivalent iron ions in the aqueous solution is preferably from 0.001 to 5 mol/l, more preferably from 0.02 to 1 mol/l. Water in which the iron salt is dissolved is not particularly limited, but is preferably ion-exchange water, sterilized water or ultrapure water.

The base used for the preparation of the mixed liquid is not particularly limited, but is preferably a base selected from the group consisting of sodium hydroxide, potassium hydroxide, aqua ammonia and urea. Of these bases, aqua ammonia and urea are more preferable. The concentration of the base, that is, the amount of the base, is not particularly limited, but is preferably from 1 to 50 moles, more preferably from 3 to 10 moles, based on mole of iron ions.

The water-soluble reducing organic liquid used for the preparation of the mixed liquid is an organic liquid which is soluble in water, and can reduce the trivalent iron ions or Fe(OH)₃ under heating conditions in the heating step. Such a water-soluble reducing organic liquid is preferably a polyol. The polyol is not particularly limited, but is preferably at least one polyol selected from the group consisting of ethylene glycol, 1,4-butanediol, hexadecanediol, diethylene glycol, triethylene glycol and tetraethylene glycol. The volume ratio of the aqueous solution containing iron ions to the water-soluble reducing organic liquid is not particularly limited, but is preferably from 1:10 to 10:1, more preferably from 1:5 to 5:1.

No particular limitation is present on conditions for the preparation of the mixed liquid. For example, the mixed liquid is prepared at ambient temperature (e.g., about 5 to 35° C.) under atmospheric pressure. For instance, the mixed liquid can be prepared by dropwise adding a base to an aqueous solution containing iron ions and a water-soluble reducing organic liquid while stirring and mixing the aqueous solution and the organic liquid.

In the preparation of the mixed liquid, a water-soluble surfactant may optionally be added. The use of the water-soluble surfactant not only controls the particle size of the resultant magnetite soft magnetic powder, but also improve the dispersibility of the magnetite soft magnetic powder present in the mixed liquid obtained after subjecting the mixed liquid to the heating step. Specific examples of such a water-soluble surfactant include, but are not particularly limited to, polyacrylic acid (AQUALIC HL-415, manufactured by NIPPON SHOKUBAI CO., LTD.), Tween 20 (available from NACALAI TESQUE, INC.) and Triton X-100 (available from NACALAI TESQUE, INC.).

In the preparation of the mixed liquid, a mixed liquid composed of two phases of an aqueous phase and an oil phase may be prepared by further adding a water-insoluble organic liquid. Usually, the crystal of the magnetite soft magnetic powder formed in the mixed liquid grows in an aqueous medium. When the two-phase mixed liquid is heated, a driving force capable of transferring a magnetite soft magnetic powder formed in the aqueous phase to the oil phase is generated, since convection occurs in the aqueous phase as a result of heating. Therefore, the magnetite soft magnetic powder is stably dispersed in the oil phase, while impurities and undesired substances remain in the aqueous phase. Thereby, a magnetite soft magnetic powder having higher crystallinity can be formed. Specific examples of the water-insoluble organic solvent include toluene, n-hexane, cyclohexane, decane, octane and benzene diethyl ether. These water-insoluble organic solvents may be used alone, or in the form of a mixture of two or more water-insoluble organic solvents.

When the water-insoluble organic liquid is added, it is preferable to further add a water-insoluble surfactant which is soluble in a water-insoluble organic liquid. The water-insoluble surfactant adheres to the surface of the magnetite soft magnetic powder when the magnetite soft magnetic powder formed by subsequent heating is transferred from the aqueous phase to the oil phase. Therefore, hydrophobicity is imparted to the entire magnetite soft magnetic powder so that the magnetite soft magnetic powder is more stably dispersed in the oil phase. Specific examples of the water-insoluble surfactant include, but are not particularly limited to, saturated fatty acids such as decanoic acid, myristic acid and stearic acid; unsaturated fatty acids such as oleic acid and linoleic acid; and aliphatic amines such as myristylamine, stearylamine and oleylamine. These water-insoluble surfactants may be used alone, or in the form of a mixture of two or more water-insoluble surfactants. The amount of the water-insoluble surfactant is preferably from 1 to 90% by weight, more preferably 5 to 50% by weight, based on the entire amount of the water-insoluble organic liquid. The water-insoluble surfactant may also be used in the form of a solution in the water-insoluble organic solvent.

Next, the thus obtained mixed liquid is heated under pressure. Thereby, the reduction reaction of Fe(OH)₃ in the mixed liquid proceeds and crystal growth occurs to form the magnetite soft magnetic powder from Fe(OH)₃. Specifically, the resultant mixed liquid is charged in a pressure-tight vessel and heated to from a pressurized state in the pressure-tight vessel, and then the mixed liquid is heated. Preferably, the mixed liquid is heated to a desired temperature, and then maintained for a specific time while substantially maintaining the desired temperature. When the temperature of the mixed liquid is excessively low, the contribution of the water-soluble reducing organic liquid to the reaction reduces, which makes it difficult to form a magnetite soft magnetic powder. When the temperature of the mixed liquid is excessively high, the pressure in the pressure-tight vessel increases so that a risk of explosion or the like may arise. When the time period for maintaining the temperature of the mixed liquid is too short, a magnetite soft magnetic powder having further deteriorated magnetic characteristics is likely to be formed. When this time period is too long, the rate of variation in particle size further increases so that the variation in particle size increases. Therefore, in a preferable embodiment, the mixed liquid is heated until its temperature reaches 150° C. to 300° C., preferably 160 to 250° C., and such temperature of the mixed liquid is maintained for 1 minute to 4 hours, preferably for 30 minutes to 2 hours. The pressure in the pressure-tight vessel is preferably from 0.2 to 10 MPa, more preferably from 0.3 to 7 MPa.

There is no particular limitation on a heating means, and any heating means can be used. Specific examples thereof include an autoclave, a thermostat bath and a microwave applicator. Of these heating means, a microwave applicator is preferable. Microwave irradiation is advantageous since the mixed liquid can be quickly heated. Although microwave irradiation is continued until the temperature of the mixed liquid reaches the desired temperature, irradiation is preferably continued while varying the output so as to maintain the desired temperature. The frequency of microwave is not particularly limited as long as the mixed liquid can be heated to the desired temperature, for example, preferably from 150 to 300° C., more preferably from 160 to 250° C. For example, a microwave applicator utilizing a frequency of 2.45 GHz is particularly preferable, since it is low-cost and is economically advantageous, and both a decrease in time required for reaching the desired temperature and control of the temperature can be appropriately achieved. Examples of the device capable of controlling the output of microwave include MicroSYNTH (manufactured by Milestone General K.K.).

The thus obtained magnetite soft magnetic powder is preferably washed, filtered and dried. Impurities and undesired substances can be removed from the surface of particles by washing the formed magnetite soft magnetic powder. Examples of a washing liquid include water, an alcohol such as ethanol, and an aqueous solvent containing a water-soluble surfactant. The drying temperature is preferably from 30 to 150° C., more preferably from 40 to 95° C.

In the present invention, the content of the magnetite soft magnetic powder in the soft magnetic layer is preferably from 65 to 90% by weight, more preferably from 70 to 85% by weight. A densely filled soft magnetic layer can be formed by the use of the fine spherical or ellipsoidal magnetite soft magnetic powder. The thickness of the soft magnetic layer is preferably within a range from 0.1 to 3.5 μm. When the thickness is within this range, the action of the soft magnetic layer is sufficiently ensured and the thickness of the entire magnetic recording medium is reduced. In the present specification, the film thickness is a mean value obtained by observing cross sections at plural points of the magnetic recording medium (50 μm long) with a scanning electron microscope (magnification: 5 to 200,000).

In the magnetic recording medium of the present invention, the ferromagnetic layer as the upper layer comprises spherical, ellipsoidal or plate-form ferromagnetic powder. To obtain a coating type magnetic recording medium having an axis of easy magnetization in a vertical direction to the magnetic layer for the purpose of increasing the output, ideally spherical ferromagnetic powder free from anisotropy is used. However, it is essentially difficult to produce ferromagnetic powder with a small axial ratio based on acicular ferromagnetic powder, since the coercive force of the conventional acicular ferromagnetic powder such as iron-based metal magnetic powder depends on magnetic shape anisotropy as described above.

Therefore, in the present invention, spherical, ellipsoidal or plate-form ferromagnetic powder with small anisotropy such as iron nitride-based magnetic powder, Co-based magnetic powder, etc., and plate-form ferromagnetic powder such as barium ferrite-based magnetic powder, etc. are used as the ferromagnetic powder in the upper magnetic layer. A magnetic layer having an axis of easy magnetization in a vertical direction can be obtained by orienting the particles of the spherical, ellipsoidal or plate-form ferromagnetic powder having a small axial ratio in the vertical direction. The axial ratio of the ferromagnetic powder is preferably 2.5 or less, more preferably from 1.0 to 2.0. When the axial ratio exceeds 2.5, the particles of the ferromagnetic powder may not be vertically oriented so that the reproduction output may decrease in the case of short wavelength recording. Among those ferromagnetic powders, the iron nitride-based magnetic powder and the Co-based magnetic powder have a high coercive force, even if they are spherical or ellipsoidal ferromagnetic powders with small anisotropy, because they have excellent crystal magnetic anisotropy. Because of the crystal magnetic anisotropy, the axes of easy magnetization of the powder are arrayed in the vertical direction, and the surface smoothness of the magnetic layer is not degraded, even if the particles of the ferromagnetic powder are vertically oriented. Thus, the magnetic layer with excellent surface smoothness suitable for high density recording can be formed even when the ferromagnetic layer has a small thickness of 5 to 150 nm. Herein, the spherical, ellipsoidal or plate-form shape means a shape having small anisotropy, such as sphere, ellipsoid, plate, etc.

The spherical, ellipsoidal or plate-form ferromagnetic powder preferably has a particle size of 5 to 50 nm, more preferably 8 to 30 nm, still more preferably 10 to 25 nm. The filling property of the ferromagnetic layer can be improved by the user of the fine spherical, ellipsoidal or plate-form ferromagnetic powder. Herein, the particle size of the ferromagnetic powder means the diameter of spherical ferromagnetic particles, the major axis length of ellipsoidal ferromagnetic particles, or the largest plate size of plate-form ferromagnetic particles. Herein, the axial ratio means a ratio of the major axis length to the minor axis length in the case of ellipsoidal ferromagnetic particles or a ratio of the plate diameter to the smallest plate size in the case of plate-form ferromagnetic particles. In the case of spherical ferromagnetic particles, an axial ratio is “one”.

The BET specific surface area of the ferromagnetic particles is preferably from 40 to 200 m²/g, more preferably from 50 to 200 m²/g, still more preferably from 60 to 200 m²/g. When the BET specific surface area is smaller than 40 m²/g, the coercive force of the ferromagnetic particles tends to decrease. When the BET specific surface area exceeds 200 m²/g, paint dispersibility decreases, or the ferromagnetic powder becomes chemically unstable.

Preferably, the coercive force of the ferromagnetic powder is from 119.4 to 318.5 kA/m, and the saturation magnetization thereof is from 70 to 160 Am²/kg. By the use of the ferromagnetic powder having such a high coercive force and such a high saturation magnetization, a high reproduction output can be obtained during recording with short wavelengths.

When iron nitride-based magnetic powder is used as the ferromagnetic powder in the present invention, iron nitride-based magnetic powder having a Fe₁₆N₂ phase as a main phase is preferable. When a highly crystalline Fe₁₆N₂ phase is contained in the iron nitride-based magnetic particle as the main phase, the coercive force and saturation magnetization of the magnetic particle can be improved. For example, spherical, ellipsoidal or plate-form iron nitride-based magnetic powder having such a Fe₁₆N₂ phase as a main phase is described in, for example, JP-A-2000-277311. Among iron nitride-based magnetic powder of this type, iron nitride-based powder containing 1 to 20 atomic % of nitrogen relative to iron is preferable. In the iron nitride-based magnetic powder, a part of iron may be substituted by other transition metal element. Specific examples of the other transition metal element include Mn, Zn, Ni, Cu, Co, etc. One or more of these transition metal elements may be contained in the iron-nitride-based magnetic particle. Among them, transition metal elements, Co and Ni are preferred, of which Co is particularly preferred since Co is most effective to improve the saturation magnetization of the magnetic powder. However, the content of Co is preferably not larger than 10 atomic % to iron. When the content of Co is too large, a longer time may be required for nitriding.

The iron nitride-based magnetic particle may further contain a rare earth element. Particularly preferable is an iron nitride-based magnetic particle having a two-layered structure which comprises an inner layer containing iron nitride having a Fe₁₆N₂ phase as a main phase, and an outer layer mainly containing the above-described rare earth element, because such an iron nitride-based magnetic particle has high dispersibility and an excellent shape-maintaining property, in spite of its high coercive force. Specific examples of such a rare earth element include yttrium, ytterbium, cesium, praseodymium, lanthanum, europium, neodymium, etc. Each of these rare earth elements may be used alone, or a plurality of them may be used in combination. Among them, yttrium, samarium and neodymium are preferable because they have a high shape-maintaining effect during a reduction reaction. The total content of the rare earth element(s) is preferably from 0.05 to 20 atomic %, more preferably from 0.1 to 15 atomic %, most preferably from 0.5 to 10 atomic %, based on the amount of iron. When the amount of the rare earth element is too small, the dispersibility-improving effect tends to decrease, and the particle shape-maintaining effect during a reduction reaction deteriorates. When the amount of the rare earth element is too large, a portion of an unreacted rare earth element increases, which may interfere with the dispersion of the magnetic powder or a coating operation, or which may cause excessive decrease in coercive force and saturation magnetization.

The iron nitride-based magnetic particle may contain boron, silicon, aluminum and/or phosphorus. The iron nitride-based magnetic particle containing such an element can have high dispersibility. The addition of these elements is advantageous in view of costs, because they are inexpensive as compared with the rare earth elements. The total content of these elements, i.e., boron, silicon, aluminum and phosphorus is preferably from 0.1 to 20 atomic %, based on iron. When the content of these elements is too small, the particle shape-maintaining effect is low. When the content of these elements is too large, the saturation magnetization of the magnetic powder tends to decrease. The iron nitride-based magnetic particle may optionally contain carbon, calcium, magnesium, zirconium, barium, strontium or the like. The use of any of these elements in combination with a rare earth element achieves a higher particle shape-maintaining effect and higher dispersibility.

While a process for manufacturing iron nitride-based magnetic powder is not limited, iron nitride-based magnetic powder can be manufactured by a process described in U.S. Pat. No. 7,238,439 B1, the disclosure of which is herein incorporated by reference in its entirety (corresponding to JP-A-2004-273094). In concrete, an iron oxide or an iron hydroxide is used as a raw material. For example, hematite, magnetite, geothite or the like is used as the iron oxide or the iron hydroxide. The particle size of the raw material is preferably from 5 to 80 nm, more preferably from 5 to 50 nm, still more preferably from 5 to 30 nm, although not limited thereto. When the particle size is too small, particles tend to be sintered during a reduction treatment. When the particle size is too large, a reduction treatment is less uniformly carried out, and the control of the particle size and magnetic characteristics of the resultant iron nitride-based magnetic powder is difficult.

The above-described raw material may be coated with the rare earth element described above. For example, the raw material is dispersed in an aqueous solution of an alkali or an acid; a salt of a rare earth element is dissolved in the dispersion; and the resulting dispersion is subjected to neutralization or the like to precipitate and deposit a hydroxide or a hydrate containing the rare earth element on the raw material. Alternatively, the raw material may be coated with an element such as boron, silicon, aluminum, phosphorus or the like. For example, a solution of a compound comprising any of the above elements is prepared; and the raw material is immersed in this solution so as to be coated with boron, silicon, aluminum, phosphorus or the like. To efficiently carry out the coating treatment, an additive such as a reducing agent, a pH buffer, a particle size-controlling agent, etc. may be further added to the solution. In the coating treatment, the rare earth element and the element such as boron, silicon, aluminum, phosphorus or the like may be concurrently or alternately coated on the raw material.

Next, the raw material coated as above is heated and reduced in a hydrogen stream. There is no particular limitation on a reducing gas: a reducing gas such as a carbon monoxide gas or the like other than the hydrogen gas may be used. The reducing temperature is desirably from 300 to 600° C. When the reducing temperature is lower than 300° C., the reduction reaction is not likely to sufficiently proceed. When the reducing temperature is higher than 600° C., the particles are likely to be sintered.

After the reduction, a nitriding treatment is carried out to obtain iron nitride-based magnetic powder comprising iron and nitrogen as constituent elements. Preferably, an ammonia-containing gas is used in the nitriding treatment. Besides an ammonia gas, a gas mixture of an ammonia gas with a carrier gas such as a hydrogen gas, a helium gas, a nitrogen gas, an argon gas or the like may be used. The nitrogen gas is particularly preferable because of its cheapness. The nitriding temperature is preferably from 100 to 300° C. When the nitriding temperature is too low, the nitriding does not sufficiently proceed, resulting in a poor effect to increase a coercive force.

When the nitriding temperature is too high, the nitriding is excessively accelerated to increase the proportion of a Fe₄N phase or a Fe₃N phase, resulting in a lower coercive force and also the excessive decrease of a saturation magnetization. The conditions for the nitriding treatment are preferably selected so that the content of nitrogen is from 1 to 20 atomic % based on iron. When the content of nitrogen is too small, the amount of a Fe₄₆N₂ phase produced decreases, which leads to a poor coercive force-improving effect. When the content of nitrogen is too large, a Fe₄N phase or a Fe₃N phase is more likely formed, which results in a lower coercive force and also the excessive decrease of a saturation magnetization.

A manufacturing process of the Co-based magnetic powder is not particularly limited, and a conventional electroless deposition process may be used. For example, an aqueous solution containing a cobalt compound such as cobalt chloride, a reducing agent such as sodium hypophosphite, a complexing agent such as sodium citrate, and a particle size-controlling agent such as gelatin is mixed with an aqueous alkaline solution to adjust the pH, and the resulting mixture is mixed with a reaction initiator such as palladium chloride or the like to form Co-based magnetic powder. A manufacturing process of the barium ferrite magnetic powder is not particularly limited, and a conventional glass crystallization process and the like may be used. For example, barium oxide, iron oxide, a metal oxide for substituting iron and a glass-forming material such as boron oxide, etc. are mixed in such amounts that a desirable ferrite composition is attained, the mixture is molten and then quenched and reheated. Thereafter, the mixture is washed and milled to obtain barium ferrite magnetic powder.

Although there is no particular limitation on a method for producing a barium ferrite magnetic powder, a conventional glass crystallization method may be exemplified. For example, a barium ferrite magnetic powder is produced formed by mixing barium oxide, iron oxide, an oxide of a metal for substituting iron and a glass-forming material such as boron oxide in such amounts that a desirable ferrite composition is attained, and melting and quenching the mixture to form an amorphous material, which is then reheated, washed and milled.

The content of the spherical, ellipsoidal or plate-form ferromagnetic powder in the ferromagnetic layer is preferably from 40 to 90% by weight, more preferably from 46 to 81% by weight. The ferromagnetic layer having a high content of the ferromagnetic powder can reduce the particle noise.

In the present invention, since the ferromagnetic layer contains the spherical, ellipsoidal or plate-form ferromagnetic powder suitable for vertical orientation, the spherical, ellipsoidal or plate-form ferromagnetic particles contained in a paint for the ferromagnetic layer to be applied as the upper layer can be efficiently oriented in a magnetic field. Accordingly, the ferromagnetic layer can have both a high vertical orienting property with a squareness of from 0.70 to 0.96 and excellent surface smoothness. According to the present invention, it is also possible to form a ferromagnetic layer having a high orienting property with a squareness of at least 0.92, and it is therefore possible to provide a magnetic recording medium suitable for recording with short wavelengths. Ideally, the squareness in the vertical direction is one (1), that is, the axes of easy magnetization of all the ferromagnetic particles are directed in the vertical direction. However, ferromagnetic particles such as iron-nitride-based magnetic particles and Co-based magnetic particles include some ferromagnetic particles shaped ellipsoidal or the like having a certain anisotropy. Consequently, the axes of easy magnetization of such ferromagnetic particles are sometimes inclined obliquely from the vertical direction by the mechanical orientation during a coating operation. For this reason, the ferromagnetic layer of the present invention has an axis of easy magnetization substantially in a vertical direction, wherein the squareness in the vertical direction is from 0.70 to 0.98. Herein, the squareness of the ferromagnetic layer is a value measured with a vertical Kerr rotational angle meter (external magnetic field: 127 kA/m). When the squareness is measured with a sample vibration magnetometer, the squareness of a magnetic recording medium comprising an upper magnetic layer with a thin thickness shows a larger value than an intrinsic value. For this reason, the squareness in the vertical direction can be correctly measured by measuring the vertical Kerr rotation. The vertical Kerr rotation is measured with a vertical Kerr rotation meter such as K-250 manufactured by JASCO Corporation and BH-810CP manufactured by NEOARK Corporation.

The coercive force of the ferromagnetic layer in the vertical direction is preferably from 80 to 320 kA/m. When the coercive force is smaller than the lower limit, it may be difficult to obtain a high output during recording with short wavelengths. When the coercive force is larger than the upper limit, it may be difficult to perform saturation recording with a magnetic head. The product (Br.δ) of the residual magnetic flux density (Br) and the thickness (δ) of the ferromagnetic layer is preferably from 0.001 to 0.06 μTm, more preferably from 0.004 to 0.04 μTm, since the saturation of the MR head is suppressed and a high SNR is achieved.

The thickness of the ferromagnetic layer is preferably from 5 to 150 nm, more preferably from 15 to 150 nm to reduce the thickness loss in short wavelength recording. The ferromagnetic layer with a thickness within this range can effectively increase a reproduction output in short wavelength recording and also prevent the degradation of magnetization due to heat fluctuation. When this thickness is smaller than 5 nm, uniform coating is impossible.

The surface roughness (Ra) of the ferromagnetic layer is preferably 2.5 nm or less, more preferably from 1.0 to 3.2 nm. The magnetic recording medium of the present invention comprises the lower layer containing the spherical or ellipsoidal magnetite soft magnetic powder having a low coercive force, and the upper layer containing the spherical, ellipsoidal or plate-form ferromagnetic powder having a high coercive force and a high saturation magnetization. Therefore, the ferromagnetic layer having a very smooth surface can be obtained despite the vertical orientation treatment, as described above. Accordingly, the contact between the magnetic record medium and a magnetic head is improved and thus a higher reproduction output is obtained. The average surface roughness is a value found by measuring the roughness on the surface of the ferromagnetic layer with a three dimensional surface structure analyzer (“NewView 5000 manufactured by ZYGO) by a scanning white-light interferometry (scan length: 5 μm; and measuring view field: 350 μm×260 μm).

As the nonmagnetic substrate, any of the conventional nonmagnetic substrates for magnetic recording media can be used. Examples thereof include plastic films with a thickness of usually from 2 to 8 μm, particularly from 2 to 7 μm, made of polyesters such as polyethylene terephthalate and polyethylene naphthalate, polyolefins, cellulose triacetate, polycabonate, polyamide, polyimide, polyamideimide, polysulfone, aramid, aromatic polyamide, etc.

As a binder for use in the ferromagnetic layer or the soft magnetic layer, for example, at least one resin selected from the group consisting of vinyl chloride resins, nitrocellulose resins, epoxy resins and polyurethane resins is used. Specific examples of the vinyl chloride resins include vinyl chloride resins, vinyl chloride-vinyl acetate copolymer resins, vinyl chloride-vinyl alcohol copolymer resins, vinyl chloride-vinyl acetate-vinyl alcohol copolymer resins, vinyl chloride-vinyl acetate-maleic anhydride copolymer resins, vinyl chloride-hydroxyl group-containing alkyl acrylate copolymer resins, etc. Among them, a blend of a vinyl chloride resin and a polyurethane resin is preferable, and a blend of a vinyl chloride-hydroxyl group-containing alkyl acrylate copolymer resin and a polyurethane resin is more preferable. These binders preferably have a functional group in order to improve the dispersibility of the powder and to increase the filling rate. Specific examples of such a functional group include a group of the formula: COOM, SO₃M, OSO₃M, P═O(OM)₃ or O—P═O(OM)₂ (in which M is a hydrogen atom, an alkali metal salt or an amine salt), a group of the formula: OH, NR¹R² or NR³R⁴R⁵ (in which each of R¹, R², R³, R⁴ and R⁵ is a hydrogen atom or a hydrocarbon group usually having 1 to 10 carbon atoms), an epoxy group, etc. When two or more binder resins are used in combination, the functional groups of the resins preferably have the same polarity. Above all, the combination of the resins both having —SO₃M groups is preferable. The binder is used in an amount of from 7 to 50 parts by weight, preferably from 10 to 35 parts by weight, per 100 parts by weight of the ferromagnetic powder or the magnetite soft magnetic powder. Especially preferable is the use of 5 to 30 parts by weight of a vinyl chloride resin in combination with 2 to 20 parts by weight of a polyurethane resin.

It is also preferable to use the binder in combination with a thermocurable crosslinking agent which is bound to the functional group of the binder to form a crosslinked structure. Examples of the crosslinking agent include isocyanate compounds such as tolylene diisocyanate, hexamethylene diisocyanate, isophorone diisocyanate, etc.; reaction products of isocyanate compounds with compounds having a plurality of hydroxyl groups, such as trimethylolpropane, etc.; and various polyisocyanates such as condensed products of isocyanate compounds. The crosslinking agent is used in an amount of usually from 10 to 50 parts by weight per 100 parts by weight of the binder.

Preferably, the ferromagnetic layer or the soft magnetic layer contains carbon black and a lubricant in order to improve the electric conductivity and surface lubricity of the layer. Specific examples of carbon black include acetylene black, furnace black and thermal black. The average particle size of carbon black is preferably from 5 to 200 nm, more preferably from 10 to 100 nm. In the ferromagnetic layer, the content of carbon black is preferably from 0.2 to 5 parts by weight, more preferably from 0.5 to 4 parts by weight, per 100 parts by weight of the ferromagnetic powder. In the soft magnetic layer, the content of carbon black is preferably from 15 to 35 parts by weight, more preferably from 20 to 30 parts by weight, per 100 parts by weight of the magnetite soft magnetic powder. Specific examples of the lubricant include fatty acids, fatty esters, fatty amides, etc. each having 10 to 30 carbon atoms. These lubricants may be used alone or in combination of two or more of them. In the ferromagnetic layer, the content of the lubricant is preferably from 0.2 to 3 parts by weight per 100 parts by weight of the ferromagnetic powder. In the soft magnetic layer, the content of the lubricant is preferably from 0.7 to 7 parts by weight per 100 parts by weight of the magnetite soft magnetic powder.

To improve the durability and running performance of the magnetic recording medium, nonmagnetic particles such as alumina, silica or the like may be added to the ferromagnetic layer and/or the soft magnetic layer. The content of such nonmagnetic particles is preferably from 1 to 20 parts by weight per 100 parts by weight of the ferromagnetic powder or the magnetite soft magnetic powder.

Paints for the ferromagnetic layer and the soft magnetic layer may be prepared by any of the methods for preparing paints which are conventionally employed in the production of magnetic recording media. In concrete, such a method preferably comprises a kneading step using a kneader or the like, and a primary dispersing step using a sand mill, a pin mill or the like, in combination. The paints for the ferromagnetic layer and the soft magnetic layer may be applied to the nonmagnetic substrate by any coating method, such as gravure coating, roll coating, blade coating, extrusion coating or the like, which are conventionally employed in the production of magnetic recording media. The application of the paints for the ferromagnetic layer and the soft magnetic layer may be done by either one of a sequential superposing application method and a concurrent superposing application method (a wet-on-wet method).

In the coating step of the paint, a magnetic field is applied vertically to the paint which is still in a wet state, during the coating step to carry out an orientation treatment so that the axis of easy magnetization of the ferromagnetic layer is directed substantially in a vertical direction. In this orientation treatment, solenoid magnets, permanent magnets, etc. may be used. The strength of the magnetic field is preferably from 0.05 to 1 T, so as to suppress the degradation of the surface roughness of the ferromagnetic layer.

The magnetic recording medium of the present invention may additionally have a nonmagnetic layer comprising nonmagnetic particles and a binder between the nonmagnetic substrate and the soft magnetic layer in order to improve the surface smoothness and to control the viscosity of the paint and the rigidity of the tape. The thickness of the nonmagnetic layer is preferably from 0.1 to 3.0 μm, more preferably from 0.15 to 2.5 μm. Specific examples of the nonmagnetic particles are nonmagnetic particles of titanium oxide, iron oxide, aluminum oxide and the like. These nonmagnetic particles may be used alone, or some of them may be used as a mixture. In order to impart electric conductivity to the layer, carbon black such as acetylene black, furnace black, thermal black or the like may be used. As the binder, the same binder as that for use in the ferromagnetic layer may be used. The content of the binder is preferably from 7 to 50 parts by weight, more preferably from 10 to 35 parts by weight, per 100 parts by weight of the nonmagnetic particles. The nonmagnetic layer may be formed at the same time as the formation of the soft magnetic layer and the ferromagnetic layer. Alternatively, the nonmagnetic layer is formed, and then, the soft magnetic layer and the ferromagnetic layer are sequentially or simultaneously formed on the nonmagnetic layer.

The magnetic recording medium of the present invention may have a backcoat layer. The thickness of the backcoat layer is preferably form 0.2 to 0.8 μm, more preferably from 0.3 to 0.8 μm. The backcoat layer preferably contains carbon black such as acetylene black, furnace black, thermal black or the like. As a binder for use in the backcoat layer, the same binder as that for use in the ferromagnetic layer may be used. Above all, a combination of a cellulose resin and a polyurethane resin is preferably used in order to decrease a friction coefficient and to improve the running performance of the resultant recording medium. The content of the binder is preferably from 40 to 150 parts by weight, more preferably from 50 to 120 parts by weight, per 100 parts by weight of the magnetic powder. The backcoat layer may be formed prior to the formation of the soft magnetic layer and the ferromagnetic layer, or may be formed after the formation of the soft magnetic layer and the ferromagnetic layer.

Hereinafter, the present invention will be described in more detail by the Examples which, however, should not be construed as limiting the scope of the present invention in any way. In the following Examples, “parts” are “parts by weight”, unless otherwise specified.

### EXAMPLES

### Preparation of Magnetite Soft Magnetic Powder

1. Magnetite Soft Magnetic Powder (M-1)

1.3 Parts of iron(III) chloride was dissolved in 10 parts of water. To this aqueous solution, 27 parts of ethylene glycol, 3 parts of 28 wt. % aqua ammonia and 0.4 part of a water-soluble surfactant (polyacrylic acid, molecular weight: 10,000) were added, followed by stirring with a magnetic stirrer.

The resultant mixed liquid was charged in a vessel for a hydrothermal reaction and a microwave-assisted hydrothermal reaction was performed using a microwave hydrothermal reaction apparatus (MicroSYNTH manufactured by Milestone General K.K.). During the hydrothermal reaction, the maximum output of microwave was adjusted to 1,000 W and the output was variably controlled according to the measured temperature so that the mixed liquid was heated to 220° C. over 10 minutes (pressure in vessel: 0.8 MPa). After maintaining the temperature at 220° C. for about 1 hour, microwave irradiation was completely terminated and the mixed liquid was allowed to cool down to room temperature. After cooling, the powder formed in the mixed liquid was washed, filtrated and dried to obtain a magnetite soft magnetic powder (M-1). The resultant powder was analyzed by powder X-ray diffraction to confirm that the powder consisted of a magnetite single phase.

2. Magnetite Soft Magnetic Powder (M-2)

A magnetite soft magnetic powder (M-2) was produced in the same manner as in the production of the magnetite soft magnetic powder (M-1) except that the temperature in the microwave-assisted hydrothermal reaction was changed to 170° C. The resultant powder was analyzed by powder X-ray diffraction to confirm that the powder consisted of a magnetite single phase.

3. Magnetite Soft Magnetic Powder (M-3)

A magnetite soft magnetic powder (M-3) was produced in the same manner as in the production of the magnetite soft magnetic powder (M-1) except that the temperature in the microwave-assisted hydrothermal reaction was changed to 245° C. The resultant powder was analyzed by powder X-ray diffraction to confirm that the powder consisted of a magnetite single phase.

4. Magnetite Soft Magnetic Powder (M-4)

A magnetite soft magnetic powder (M-4) was produced in the same manner as in the production of the magnetite soft magnetic powder (M-1) except that the amount of the water-soluble surfactant to be added was changed to 0.2 part. The resultant powder was analyzed by powder X-ray diffraction to confirm that the powder consisted of a magnetite single phase.

5. Magnetite Soft Magnetic Powder (M-5)

A magnetite soft magnetic powder (M-5) was produced in the same manner as in the production of the magnetite soft magnetic powder (M-1) except that the time of the microwave-assisted hydrothermal reaction was changed to 45 minutes. The resultant powder was analyzed by powder X-ray diffraction to confirm that the powder consisted of a magnetite single phase.

6. Magnetite Soft Magnetic Powder (M-6)

A magnetite soft magnetic powder (M-6) was produced in the same manner as in the production of the magnetite soft magnetic powder (M-1) except that the maximum output of microwave was changed to 1,200 W and the heating time up to 220° C. was changed to 8 minutes. The resultant powder was analyzed by powder X-ray diffraction to confirm that the powder consisted of a magnetite single phase.

7. Magnetite Soft Magnetic Powder (M-7)

A magnetite soft magnetic powder (M-7) was produced in the same manner as in the production of the magnetite soft magnetic powder (M-1) except that the time of the microwave-assisted hydrothermal reaction was changed to 2.5 hours. The resultant powder was analyzed by powder X-ray diffraction to confirm that the powder consisted of a magnetite single phase.

8. Magnetite Soft Magnetic Powder (M-8)

A magnetite soft magnetic powder (M-8) was produced in the same manner as in the production of the magnetite soft magnetic powder (M-1) except that the amount of the water-soluble surfactant to be added was changed to 0.05 part. The resultant powder was analyzed by powder X-ray diffraction to confirm that the powder consisted of a magnetite single phase.

9. Magnetite Soft Magnetic Powder (M-9)

A magnetite soft magnetic powder (M-9) was produced in the same manner as in the production of the magnetite soft magnetic powder (M-1) except that the temperature in the microwave-assisted hydrothermal reaction was changed to 260° C. The resultant powder was analyzed by powder X-ray diffraction to confirm that the powder consisted of a magnetite single phase.

10. Magnetite Soft Magnetic Powder (M-10)

A magnetite soft magnetic powder (M-10) was produced in the same manner as in the production of the magnetite soft magnetic powder (M-1) except that the temperature in the microwave-assisted hydrothermal reaction was changed to 140° C. The resultant powder was analyzed by powder X-ray diffraction to confirm that the powder consisted of a magnetite single phase.

With the magnetite soft magnetic powder thus obtained, the shape, particle size, rate of variation in particle size, saturation magnetization and coercive force were evaluated. The results are shown in TABLE 1.

TABLE 1

| Magnetite | | | Rate of | Saturation | |
|---|---|---|---|---|---|
| soft | | Particle | variation | magnet- | Coercive |
| magnetic | Particle | size | in particle | ization | force |
| powder | shape | (nm) | size (%) | (Am²/kg) | (kA/m) |
| M-1 | Substantially | 9 | 18 | 45 | 8 |
| | spherical | | | | |
| M-2 | Substantially | 8 | 16 | 15 | 7 |
| | spherical | | | | |
| M-3 | Substantially | 9 | 18 | 55 | 8 |
| | spherical | | | | |
| M-4 | Substantially | 30 | 18 | 45 | 8 |
| | spherical | | | | |
| M-5 | Substantially | 9 | 11 | 45 | 8 |
| | spherical | | | | |
| M-6 | Substantially | 9 | 18 | 45 | 12 |
| | spherical | | | | |
| M-7 | Substantially | 9 | 25 | 45 | 8 |
| | spherical | | | | |
| M-8 | Substantially | 35 | 18 | 45 | 8 |
| | spherical | | | | |
| M-9 | Substantially | 9 | 18 | 65 | 7 |
| | spherical | | | | |
| M-10 | Substantially | 9 | 18 | 5 | 6 |
| | spherical | | | | |

### Preparation of Iron Nitride-Based Magnetic Powder:

Iron (II) sulfate heptahydrate (116 parts) and iron (III) nitrate nonahydrate (547 parts) were dissolved in water (1,500 parts). Separately, sodium hydroxide (150 parts) was dissolved in water (1,500 parts). To the above aqueous solution of the two kinds of salts of iron, the aqueous solution of sodium hydroxide was added, and then the mixture was stirred for 20 minutes to form magnetite powder. The obtained magnetite powder was charged in an autoclave and heated at 200° C. for 4 hours. The resulting magnetite powder was subjected to a hydrothermal treatment, washed with water and dried to obtain substantially spherical or ellipsoidal magnetite powder with a particle size of 25 nm.

The magnetite powder produced in the previous step (10 parts) was dispersed in water (500 parts) for 30 minutes with an ultrasonic disperser. Yttrium nitrate (2.5 parts) was added to and dissolved in this liquid dispersion, and the resulting solution was stirred for 30 minutes. Separately, sodium hydroxide (0.8 part) was dissolved in water (100 parts). This aqueous sodium hydroxide solution was dropwise added to the above dispersion over about 30 minutes. After completion of the addition, the mixture was further stirred for one hour. By this treatment, yttrium hydroxide was deposited and coated on the surfaces of the magnetite powder. The resultant coated magnetite powder was washed with water, filtered and dried at 90° C. to obtain magnetite powder the particles of which were coated with yttrium hydroxide on their surfaces.

The magnetite powder the particles of which were coated with yttrium hydroxide on the surfaces was reduced by heating at 450° C. for 2 hours in a stream of a hydrogen gas to obtain yttrium-containing iron-based magnetic powder. Next, the obtained magnetic powder was cooled to 150° C. over about one hour while flowing the hydrogen gas. When the magnetic powder was cooled to 150° C., the hydrogen gas was switched to an ammonia gas, and the magnetic powder maintained at 150° C. was nitrided for 30 hours. After that, the magnetic powder was cooled from 150° C. to 90° C. while flowing the ammonia gas, and then, at 90° C., the ammonia gas was switched to a gas mixture of an oxygen gas and a nitrogen gas, followed by stabilization of the magnetic powder for 2 hours. Then, the magnetic powder was cooled from 90° C. to 40° C. and maintained at 40° C. for about 10 hours while flowing the gas mixture, and then were taken out into an air to obtain iron nitride-based magnetic powder (N-1).

The contents of yttrium and nitrogen based on iron in the iron nitride-based magnetic particle thus obtained were measured by means of fluorescent X-ray analysis. As a result, the contents of yttrium and nitrogen were 5.3 atomic % and 10.8 atomic %, respectively. A profile indicating a Fe₁₆N₂ phase was observed from an X-ray diffraction pattern of the magnetic powder. The shapes of the magnetic particles were observed with a high-resolution analytical transmission electron microscope. As a result, it was confirmed that the iron nitride-based magnetic particles were substantially spherical, having a particle size of 20 nm and an axial ratio of 1.1. The specific surface area thereof determined by the BET method was 53.2 m²/g. The magnetic characteristics of the iron nitride-based magnetic powder were measured. As a result, the saturation magnetization was 135.2 Am²/kg, and the coercive force was 226.9 kA/m.

### Preparation of Co-Based Magnetic Powder:

CoCl₂.6H₂O (13 parts), NaPH₂O₂.H₂O (20 parts), C₆H₅O₇Na₃.2H₂O (30 parts), H₃BO₃ (15 parts) and gelatin (10 parts) were dissolved in water (1,000 parts). This aqueous solution was adjusted to pH of 8.3 with a 10N aqueous sodium hydroxide solution, and then heated to 85° C. After heating, PbCl₂ (one part) was dropwise added to the aqueous solution, and the mixture was reacted for 45 minutes. After completion of the reaction, Co-based magnetic powder formed in the aqueous solution was recovered with magnets, and was washed with water and dried to obtain Co-based magnetic powder (C-1).

The shapes of the Co-based magnetic particles thus obtained were observed with the high-resolution analytical transmission electron microscope. As a result, it was confirmed that the particles were substantially spherical, having a particle size of 20 nm and an axial ratio of 1.1. The specific surface area thereof determined by the BET method was 53.2 m²/g. The magnetic characteristics of the Co-based magnetic powder were measured. As a result, the saturation magnetization was 110 Am²/kg, and the coercive force was 127 kA/m.

### Preparation of Barium Ferrite Magnetic Powder:

A mixed solution was prepared by dissolving 1 mole of ferric chloride, ⅛ mole of barium chloride, ⅛ mole of cobalt chloride, 1/40 mole of titanium chloride and 1/40 mole of nickel chloride in 1 liter of water. The mixed solution was cooled to 10° C. and then added to 1 liter of an aqueous solution containing 3 moles of sodium hydroxide dissolved, followed by stirring. Un this step, the aqueous sodium hydroxide solution was cooled to 10° C. and a coprecipitation reaction was performed while maintaining the temperature during mixing and stirring at 10° C. The resultant suspension was aged at room temperature for 1 day, and then the precipitate was placed in an autoclave and heated and reacted at 220° C. for 4 hours to obtain a precursor of barium ferrite.

The resultant barium ferrite precursor was sufficiently washed with water until pH of washing water became 8 or less to prepare a suspension in which the barium ferrite precursor was precipitated so that the whole volume containing the barium ferrite precursor reached one liter. After removing the supernatant from the suspension, 500 g of sodium chloride as a flux was added to the suspension and dissolved by stirring. Thereafter, the suspension of the barium ferrite precursor, which contained sodium chloride dissolved therein, was charged in a tray having a large area and then water was evaporated off by heating to 100° C. with a dryer.

Next, the thus obtained mixture of the barium ferrite precursor and sodium chloride was comminuted, thoroughly mixed and then charged in a crucible. Sodium chloride as the flux was molten by heating the crucible at 850° C. for 20 minutes, and then the temperature was lowered to 780° C. The mixture was heated at 780° C. for about 10 hours and then cooled to room temperature. Then, sodium chloride was leached out by washing with water, and a barium ferrite magnetic powder (B-1) was recovered.

The thus obtained barium ferrite magnetic powder was observed by a high-resolution transmission electron microscope. As a result, it was confirmed that the barium ferrite magnetic powder was in the form of plate-form particles and had a particle size of 20 nm. Also, magnetic characteristics of this barium ferrite magnetic powder were measured. The saturation magnetization was 48.2 Am²/kg and the coercive force was 180 kA/m.

### Production of Magnetic Recording Medium

### Example 1

### Preparation of Paint for Nonmagnetic Layer

The components of a paint for a nonmagnetic layer shown in TABLE 2 below were kneaded with a kneader, and the mixture was dispersed with a sand mill (residence time: 60 minutes), and polyisocyanate (6 parts) was added thereto. The mixture was stirred and filtered to prepare a paint for a nonmagnetic layer.

TABLE 2

| Components of Paint for Nonmagnetic Layer | Amount | |
|---|---|---|
| Iron oxide powder (av. particle size: 55 nm) | 70 | parts |
| Alumina powder (av. particle size: 80 nm) | 10 | parts |
| Carbon black (av. particle size: 25 nm) | 20 | parts |
| Vinyl chloride-hydroxypropyl methacrylate | 10 | parts |
| copolymer resin | | |
| (contained —SO₃Na groups: 0.7 × 10⁻⁴ eq./g) | | |
| Polyester polyurethane resin | 5 | parts |
| (contained —SO₃Na groups: 1.0 × 10⁻⁴ eq./g) | | |
| Methyl ethyl ketone | 130 | parts |
| Toluene | 80 | parts |
| Cyclohexanone | 65 | parts |
| Myristic acid | 1 | part |
| Butyl stearate | 1.5 | parts |

### Preparation of Paint for Soft Magnetic Layer:

The components of a paint for a soft magnetic layer shown in TABLE 3 below were kneaded with a kneader and then were dispersed with a sand mill (residence time: 60 minutes), and polyisocyanate (6 parts) was added thereto. The mixture was stirred and filtered to obtain a paint for a soft magnetic layer.

TABLE 3

| Components of paint for soft magnetic layer | Amount | |
|---|---|---|
| Magnetite soft magnetic powder (M-1) | 114 | parts |
| Vinyl chloride-hydroxypropyl methacrylate | 10 | parts |
| copolymer resin | | |
| (contained —SO₃Na groups: 0.7 × 10⁻⁴ eq./g) | | |
| Polyester polyurethane resin | 5 | parts |
| (contained —SO₃Na groups: 1.0 × 10⁻⁴ eq./g) | | |
| Methyl ethyl ketone | 100 | parts |
| Toluene | 100 | parts |
| Myristic acid | 1 | part |
| Butyl stearate | 1.5 | parts |

### Preparation of Paint for Ferromagnetic Layer:

The components (1) of a paint for a ferromagnetic layer shown in TABLE 4 below were kneaded with a kneader and then dispersed with a sand mill (residence time: 60 minutes), and the components (2) of the paint for the ferromagnetic layer shown in TABLE 5 below were added to the resulting dispersion. The mixture was stirred and filtered to obtain a paint for a ferromagnetic layer.

TABLE 4

| Components (1) of paint for ferromagnetic layer | Amount | |
|---|---|---|
| Iron nitride-based magnetic powder (N-1) | 100 | parts |
| α-Alumina (average particle size: 80 nm) | 10 | parts |
| Carbon black (average particle size: 25 nm) | 1.5 | parts |
| Vinyl chloride-hydroxypropyl methacrylate | 10 | parts |
| copolymer resin (contained —SO₃Na groups: 0.7 × | | |
| 10⁻⁴ eq./g) | | |
| Polyester polyurethane resin | 5 | parts |
| (contained —SO₃Na groups: 1.0 × 10⁻⁴ eq./g) | | |
| Methyl ethyl ketone | 116 | parts |
| Toluene | 116 | parts |
| Myristic acid | 1 | part |
| Butyl stearate | 1.5 | parts |

TABLE 5

| Components (2) of paint | | |
|---|---|---|
| for ferromagnetic layer | Amount | |
| Stearic acid | 1.5 | parts |
| Polyisocyanate | 5 | parts |
| Cyclohexanone | 133 | parts |
| Toluene | 33 | parts |

### <Coating and Orientation Treatment>

First, the paint for the nonmagnetic layer was applied to a polyethylene terephthalate film (thickness: 6 μm) as a nonmagnetic substrate, and then dried and calendered to form a nonmagnetic layer with a thickness of 2 μm.

Next, the paint for the soft magnetic layer and the paint for the ferromagnetic layer were concurrently applied to the nonmagnetic layer formed in the previous step, and then dried and calendered to form a soft magnetic layer with a thickness of 0.6 μm and a ferromagnetic layer with a thickness of 150 nm, respectively. During the application of the paints, a vertical orientation treatment was carried out by conveying the nonmagnetic substrate between a pair of permanent magnets which were disposed with their N poles and S poles opposed to each other in the thickness direction of the nonmagnetic substrate (a magnetic field strength: 0.8 T).

### Formation of Backcoat Layer:

The components of a paint for a backcoat layer shown in TABLE 6 below were dispersed with a sand mill (residence time: 45 minutes), and polyisocyanate (8.5 parts) was added thereto. The mixture was stirred and filtered to obtain a paint for a backcoat layer.

TABLE 6

| Components of paint for backcoat layer | Amount | |
|---|---|---|
| Carbon black (average particle size: 25 nm) | 40.5 | parts |
| Carbon black (average particle size: 370 nm) | 0.5 | part |
| Barium sulfate | 4.05 | parts |
| Nitrocellulose | 28 | parts |
| Polyurethane resin (containing —SO₃Na | 20 | parts |
| groups) | | |
| Methyl ethyl ketone | 100 | parts |
| Toluene | 100 | parts |
| Cyclohexanone | 100 | parts |

The above-described paint for a backcoat layer was applied to the other surface of the nonmagnetic substrate which had the magnetic layer formed on its one surface, and then dried and calendered to form a backcoat layer with a thickness of 700 nm.

### Calendering and Slitting;

A magnetic sheet consisting of the nonmagnetic substrate, the soft magnetic layer and the ferromagnetic layer formed on one surface of the nonmagnetic substrate, and the backcoat layer formed on the other surface thereof as described above was mirror-finished with a five-staged calender (temperature: 70° C.; linear pressure; 150 Kg/cm), and was wound around a sheet core. The wound magnetic sheet was aged for 48 hours at 60° C. and 40% RH. After that, the magnetic sheet was slit to form strips with a width of ½ inch. Thus, a magnetic tape was obtained.

### Example 2

A magnetic tape was produced in the same manner as in Example 1 except that magnetite soft magnetic powder (M-2) was used instead of magnetite soft magnetic powder (M-1) in the preparation of the paint for the soft magnetic layer of Example 1.

### Example 3

A magnetic tape was produced in the same manner as in Example 1 except that magnetite soft magnetic powder (M-3) was used instead of magnetite soft magnetic powder (M-1) in the preparation of the paint for the soft magnetic layer of Example 1.

### Example 4

A magnetic tape was produced in the same manner as in Example 1 except that magnetite soft magnetic powder (M-4) was used instead of magnetite soft magnetic powder (M-1) in the preparation of the paint for the soft magnetic layer of Example 1.

### Example 5

A magnetic tape was produced in the same manner as in Example 1 except that magnetite soft magnetic powder (M-5) was used instead of magnetite soft magnetic powder (M-1) in the preparation of the paint for the soft magnetic layer of Example 1.

### Example 6

A magnetic tape was produced in the same manner as in Example 1 except that magnetite soft magnetic powder (M-6) was used instead of magnetite soft magnetic powder (M-1) in the preparation of the paint for the soft magnetic layer of Example 1.

### Example 7

A magnetic tape was produced in the same manner as in Example 1 except that the thickness of the ferromagnetic layer was changed to 15 nm in the coating and orientation treatment.

### Example 8

A magnetic tape was produced in the same manner as in Example 1 except that Co-based magnetic powder (C-1) was used instead of iron nitride-based magnetic powder (N-1) in the preparation of the paint for the ferromagnetic layer of Example 1.

### Example 9

A magnetic tape was produced in the same manner as in Example 1 except that the amount of magnetite soft magnetic powder (M-1) was changed to 54 parts in the preparation of the paint for the soft magnetic layer of Example 1.

### Example 10

A magnetic tape was produced in the same manner as in Example 1 except that the amount of magnetite soft magnetic powder (M-1) was changed to 134 parts in the preparation of the paint for the soft magnetic layer of Example 1.

### Example 11

A magnetic tape was produced in the same manner as in Example 1 except that the amount of ferromagnetic powder in the components (1) of paint for ferromagnetic layer was changed to 30 parts in the preparation of the paint for ferromagnetic layer of Example 1.

### Example 12

A magnetic tape was produced in the same manner as in Example 1 except that the amount of ferromagnetic powder in the components (1) of paint for ferromagnetic layer was changed to 150 parts in the preparation of the paint for ferromagnetic layer of Example 1.

### Example 13

A magnetic tape was produced in the same manner as in Example 1 except that the magnetic field strength was changed to 0.5 T in the coating and orientation treatment of Example 1.

### Example 14

A magnetic tape was produced in the same manner as in Example 1 except that the magnetic field strength was changed to 1.0 T in the coating and orientation treatment of Example 1.

### Example 15

A magnetic tape was produced in the same manner as in Example 1 except that barium ferrite magnetic powder magnetic powder (B-1) was used instead of iron nitride-based magnetic powder (N-1) in the preparation of the paint for the ferromagnetic layer of Example 1.

### Comparative Example 1

A magnetic tape was produced in the same manner as in Example 1 except that magnetite soft magnetic powder (M-7) was used instead of magnetite soft magnetic powder (M-1) in the preparation of the paint for the soft magnetic layer of Example 1.

### Comparative Example 2

A magnetic tape was produced in the same manner as in Example 1 except that magnetite soft magnetic powder (M-8) was used instead of magnetite soft magnetic powder (M-1) in the preparation of the paint for the soft magnetic layer of Example 1.

### Comparative Example 3

A magnetic tape was produced in the same manner as in Example 1 except that magnetite soft magnetic powder (M-9) was used instead of magnetite soft magnetic powder (M-1) in the preparation of the paint for the soft magnetic layer of Example 1.

### Comparative Example 4

A magnetic tape was produced in the same manner as in Example 1 except that magnetite soft magnetic powder (M-10) was used instead of magnetite soft magnetic powder (M-1) in the preparation of the paint for the soft magnetic layer of Example 1.

### Comparative Example 5

A magnetic tape was produced in the same manner as in Example 1 except that Mn—Zn ferrite soft magnetic particles (Z-1) (saturation magnetization: 8 Am²/kg; coercive force: 6 kA/m; particle size: 12 nm; rate of variation in particle size: 31%; particle shape: substantially spherical;) was used instead of magnetite soft magnetic powder (M-1) in the preparation of the paint for the soft magnetic layer of Example 1.

With each of the magnetic tapes produced in the Examples and the Comparative Examples, a squareness in the vertical direction of the ferromagnetic layer and surface roughness of the ferromagnetic layer were measured. Also, with each of the magnetic tapes, reproduction output, particle noise and magnetic cluster sizes were evaluated by the following methods. The results are shown in TABLES 7 and 8.

### <Reproduction Output and Particle Noise>

Electromagnetic conversion characteristics were evaluated using a drum tester mounted with a metal-in-gap (MIG) head (track width: 12 μm, gap length: 0.15 μm, Bs: 1.2 T) as a recording head and a spin-valve type GMR head (track width: 2.5 μm, SH—SH width: 0.15 μm) as a reproducing head. A magnetic tape was wound around the rotary drum of the drum tester and the reproduction output (5) and broadband noise (N) at a recording density of 169 kfci were measured using a spectrum analyzer while running the magnetic tape at a relative velocity of 3.4 m/sec. The reproduction output and noise were evaluated in terms of relative values to those of Comparative Example 5 as reference values (100% and 0 dB).

### <Magnetic Cluster Size>

A signal with a recording wavelength λ of 10 μm was written on a magnetic tape using the same drum tester as that used for the evaluation of electromagnetic conversion characteristics. Leakage magnetic field images at 20 magnetization transition portions of the written signal were observed by a frequency detection method using a magnetic force microscope (Nano Scope III manufactured by Digital Instruments, Inc.). The intensity of each observed magnetization transition portion was digitized and the standard deviation from a center line was determined, and then a 20-point mean value was used as a magnetic cluster size. A probe with a cobalt alloy coating (tip curvature radius: 25 to 40 nm, coercive force: about 400 Oe, magnetic moment: about 1×10⁻¹³ emu) was used as a measurement probe, and a scanning zone was a 5 μm square and a scanning rate was 5 μm/sec.

TABLE 7

| | | Example No. | | | | | | | | | |
|---|---|---|---|---|---|---|---|---|---|---|---|
| | | E. 1 | E. 2 | E. 3 | E. 4 | E. 5 | E. 6 | E. 7 | E. 8 | E. 9 | E. 10 |
| Soft magnetic | Soft magnetic | M-1 | M-2 | M-3 | M-4 | M-5 | M-6 | M-1 | M-1 | M-1 | M-1 |
| layer | powder | | | | | | | | | | |
| | Content (wt. %) | 82.9 | 82.9 | 82.9 | 82.9 | 82.9 | 82.9 | 82.9 | 82.9 | 69.6 | 85.1 |
| Ferro-magnetic | Ferromagnetic | N-1 | N-1 | N-1 | N-1 | N-1 | N-1 | N-1 | C-1 | N-1 | N-1 |
| layer | powder | | | | | | | | | | |
| | Squareness | 0.94 | 0.92 | 0.96 | 0.94 | 0.94 | 0.94 | 0.94 | 0.94 | 0.94 | 0.94 |
| | Content (wt. %) | 73.8 | 73.8 | 73.8 | 73.8 | 73.8 | 73.8 | 73.8 | 73.8 | 73.8 | 73.8 |
| | Ra (nm) | 2.1 | 2.1 | 2.1 | 2.1 | 2.1 | 2.1 | 1.8 | 2.1 | 2.1 | 2.1 |
| | Thickness (nm) | 150 | 150 | 150 | 150 | 150 | 150 | 15 | 150 | 150 | 15 |

| | | | | | | | | | | |
|---|---|---|---|---|---|---|---|---|---|---|
| Magnetization cluster (nm) | 57.1 | 54.1 | 57.1 | 58.3 | 51.4 | 61.3 | 54.7 | 57.7 | 57.1 | 57.1 |
| Reproduction output (%) | 113 | 105 | 118 | 110 | 113 | 115 | 105 | 113 | 107 | 119 |
| Particle noise (dB) | −4.3 | −5.3 | −4.3 | −3.9 | −6.2 | −2.9 | −5.1 | −4.1 | −4.3 | −4.3 |

TABLE 8

| | | Example No. | | | | | | | | | |
|---|---|---|---|---|---|---|---|---|---|---|---|
| | | E. 11 | E. 12 | E. 13 | E. 14 | E. 15 | C.E. 1 | C.E. 2 | C.E. 3 | C.E. 4 | C.E. 5 |
| Soft | Soft magnetic | M-1 | M-1 | M-1 | M-1 | M-1 | M-7 | M-8 | M-9 | M-10 | Z-1 |
| magnetic | powder | | | | | | | | | | |
| layer | Content (wt. %) | 82.9 | 82.9 | 82.9 | 82.9 | 82.9 | 82.9 | 82.9 | 82.9 | 82.9 | 82.9 |
| Ferro-magnetic | Ferromagnetic | N-1 | N-1 | N-1 | N-1 | B-1 | N-1 | N-1 | N-1 | N-1 | N-1 |
| layer | powder | | | | | | | | | | |
| | Squareness | 0.94 | 0.94 | 0.71 | 0.96 | 0.94 | 0.88 | 0.89 | 0.88 | 0.87 | 0.85 |
| | Content (wt. %) | 45.8 | 80.9 | 73.8 | 73.8 | 73.8 | 73.8 | 73.8 | 73.8 | 73.8 | 73.8 |
| | Ra (nm) | 2.1 | 2.3 | 2.1 | 2.1 | 2.1 | 3.1 | 2.3 | 2.6 | 2.5 | 2.1 |
| | Thickness (nm) | 150 | 150 | 150 | 150 | 150 | 150 | 150 | 150 | 150 | 150 |

| | | | | | | | | | | |
|---|---|---|---|---|---|---|---|---|---|---|
| Magnetization cluster (nm) | 57.1 | 57.1 | 57.1 | 57.1 | 57.7 | 67.6 | 70.6 | 78.0 | 61.0 | 70.0 |
| Reproduction output (%) | 105 | 118 | 112 | 115 | 110 | 94 | 102 | 115 | 83 | 100 |
| Particle noise (dB) | −4.3 | −4.3 | −4.3 | −4.3 | −4.4 | −0.8 | 0.2 | 2.2 | −3.2 | 0.0 |

As can be seen from the results in TABLES 7 and 8, the magnetic cluster size upon recording can be reduced by forming a soft magnetic layer containing a magnetite soft magnetic powder which has a particle size of 8 to 30 nm, a rate of variation in particle size of 11 to 18% and a saturation magnetization of 15 to 55 Am²/kg, under a ferromagnetic layer which contains a spherical, ellipsoidal or plate-form ferromagnetic powder and has an axis of easy magnetization in the vertical direction. Therefore, reproduction output and particle noise of the magnetic tapes of the Examples are remarkably improved.

In contrast, in the case where a rate of variation in particle size is too large even if a soft magnetic layer contains a magnetite soft magnetic powder, the size of a magnetic cluster formed upon recording increases and the effect to reduce the particle noise is not sufficiently improved. In addition, the reproduction output decreases when the particle size or the rate of variation in particle size is large. It is seen that, when the magnetite soft magnetic powder has an excessively large saturation magnetization (for example, M-9), the magnetic cluster size increases and particle noise is not reduced similarly to the above case. Particle noise seems to be reduced when the magnetite soft magnetic powder has an extremely small saturation magnetization (for example, M-10). However, it may be assumed that, since the reproduction output remarkably decreases and the magnetic cluster size is relatively large in Comparative Example 4, particle noise apparently reduced as the result of decrease in reproduction output. It is seen that a Mn—Zn ferrite soft magnetic powder has a large rate of variation in particle size and magnetic tapes having a soft magnetic layer containing the soft magnetic powder of Comparative Example 5 have higher particle noise than that of magnetic tapes of the Examples having a soft magnetic layer containing the magnetite soft magnetic powder.

What is claimed is:

1. A magnetic recording medium comprising a nonmagnetic substrate, and a soft magnetic layer and a ferromagnetic layer having a thickness of 5 to 150 nm formed in this order on the nonmagnetic substrate, wherein
the ferromagnetic layer contains a spherical, ellipsoidal or plate-form ferromagnetic powder and a binder, and has an axis of easy magnetization substantially in a perpendicular direction, and
the soft magnetic layer contains a spherical or ellipsoidal magnetite soft magnetic powder having a particle size of 30 nm or less, a rate of variation in particle size of 20% or less and a saturation magnetization of 10 to 60 Am²/kg, and a binder.

2. The magnetic recording medium according to claim 1, wherein said magnetite soft magnetic powder has a coercive force of 2 to 12 kA/m.

3. The magnetic recording medium according to claim 1, wherein said ferromagnetic powder is a magnetic powder selected from the group consisting of an iron nitride-based magnetic powder and a Co-based ferromagnetic powder.

4. The magnetic recording medium according to claim 2, wherein said ferromagnetic powder is a magnetic powder selected from the group consisting of an iron nitride-based magnetic powder and a Co-based ferromagnetic powder.
